(19) United States
(12) Patent Application Publication
(10) Pub. No.: US 2016/0191741 A1
(43) Pub. Date: Jun. 30, 2016

(54) SCANNER

(71) Applicant: Funai Electric Co., Ltd., Osaka (JP)

(72) Inventors: Kanji TSUKIMORI, Kobe-shi (JP); Motoaki SANO, Osaka (JP)

(21) Appl. No.: 14/691,872

(22) Filed: Apr. 21, 2015

(30) Foreign Application Priority Data
Apr. 22, 2014 (JP) 2014-088501

(51) Int. Cl. H04N 1/17; H04N 1/10; H04N 1/00

(52) U.S. Cl. CPC H04N 1/17; H04N 1/00806; H04N 1/00824; H04N 1/10; H04N 1/00689; H04N 1/00737; H04N 2201/0081

(57) ABSTRACT

Provided is an image reading apparatus capable of preventing the increase of the number of components in order to detect whether a document is left behind on a document table. The image reading apparatus includes: a reading unit configured to read a medium; a control unit configured to generate a first image based on a result of a first reading which reads the medium and generate a second image based on a result of a second reading which is performed at a different timing from the first reading; and a first determination unit configured to determine presence or absence of the medium based on a comparison result of a common area between the first image and the second image.

### BACKGROUND OF THE INVENTION

1. Technical Field

The present invention relates to an image reading apparatus which scans a document placed on a document table, and in particular, to an image reading apparatus capable of preventing a document from being left behind on a document table.

2. Related Art

In a flatbed-type image reading apparatus, a line image sensor provided with a plurality of imaging elements arranged in a line direction scans a document placed on a document table while moving in a predetermined direction (a scan direction). In a case where such an image reading apparatus is used, a user places the document on the document table, first. Then, the user takes out the document from the document table after the document is scanned.

However, there is a case where the user forgets to take out document from the document table after the document is scanned. In this case, content of the document left behind on the document table may be seen by others. For example, in a case where a confidential matter is included in the content of the document, the confidential matter is leaked.

Thus, a technique for preventing a document from being left behind on a document table is disclosed in, for example, JP 2005-084403 A. In JP 2005-084403 A, a sensor for detecting a document being left behind is provided in an image reading apparatus. Further, it is configured whether the document is left behind on the document table based on the detection result of the sensor.

However, in the related art, a dedicated sensor is required in order to detect the document being left behind on the document table. As a result, the number of components of the image reading apparatus increases.

### SUMMARY OF THE INVENTION

Thus, the present invention provides an image reading apparatus capable of preventing the increase of the number of components in order to detect the document being left behind on the document table.

An image reading apparatus according to one aspect of the present invention includes: a reading unit configured to read a medium; a control unit configured to generate a first image based on a result of a first reading which reads the medium and generate a second image based on a result of a second reading which is performed at a different timing from the first reading; and a first determination unit configured to determine presence or absence of the medium based on a comparison result of a common area between the first image and the second image.

For example, the reading unit may perform a third reading based on a determination result of the first determination unit, the control unit may generate a third image based on the third reading, and the determination unit may include a second determination unit configured to determine that the medium is the same based on a comparison result of a first common area between the first image and the third image.

For example, the image reading apparatus may further include a notification unit configured to notify determination information based on a determination result of the second determination unit. According to this configuration, it is possible to notify a user of a medium being left behind. It is possible to allow a user to be aware of the medium being left behind through, for example, output of alarm (sound) or notification to a terminal of the user using a mail or an application.

For example, the control unit may further include a transmission unit configured to transmit the first image based on a determination result of the second determination unit. According to this configuration, in a case where it is determined that the medium is not left behind, it is possible to transmit read data for the first time. As a result, the read data is not transmitted when the medium is left behind so that the user may notice that the medium is not taken out. In addition, it is possible to prevent the read image from being transmitted unintentionally, in terms of security.

For example, the common area may be an edge portion of the medium.

For example, the reading unit may perform the third reading in a case where positions of edge portions of the medium match with one another in the first determination unit.

For example, the image reading apparatus may further include a setting unit configured to set the first common area based on an image characteristic of the first image.

According to this configuration, it is possible to set a first common area based on an image characteristic of a first image. In other words, it is possible to adaptively set the first common area for comparing the first image and the third image according to the image characteristic. Accordingly, it is possible to prevent setting an area including a lot of white pixels (that is, an area having few image characteristics) as the first common area as compared to a case where a fixed area (for example, a central area) in the first document is set as the first common area. As a result, it is possible to improve accuracy in determining whether the medium is the same.

For example, the first image may include a plurality of pixel lines including a plurality of pixels arranged in a direction perpendicular to the predetermined direction, and the setting unit may set at least one first pixel line having the number of non-white pixels equal to or larger than a first threshold number, the non-white pixel having a luminance value smaller than a predetermined luminance value, among the plurality of pixel lines included in the first image, and may set the first common area based on the at least one first pixel line.

According to this configuration, it is possible to set the first common area based on at least one first pixel line having the number of non-white pixels equal to or larger than a first threshold number. Accordingly, it is possible to prevent setting the area including a lot of white pixels (that is, the area having few image characteristics) as the first common area, and it is possible to improve accuracy in determining whether the medium is the same.

For example, the setting unit may set a pixel line closest to a start position of reading as the first pixel line among two or more of the pixel lines in a case where the two or more of the pixel lines each including the number of non-white pixels equal to or larger than the first threshold number are included in the first image.

According to this configuration, it is possible to set a pixel line closes to a reading start position among two or more of pixel lines as the first pixel line. Accordingly, it is possible to prevent the movement of a reading unit in order to read a second partial area. As a result, it is possible to realize reduction of processing loads and improvement of processing speed in order to determine whether the medium is left behind.

For example, the setting unit may set an area on the medium corresponding to the first pixel line as the first common area in a case where the number of non-white pixels included in the first pixel line is equal to or larger than a second threshold number which is larger than the first threshold number, and may set an area on the medium corresponding to the plurality of pixel lines including the first pixel line as the first common area in a case where the number of non-white pixels included in the first pixel line is below the second threshold number.

According to this configuration, it is possible to change a size of the first common area according to the number of non-white pixels included in the first pixel line. Accordingly, it is possible to prevent setting the area including a lot of white pixels (that is, the area having few image characteristics) as the first common area. As a result, it is possible to improve accuracy in determining whether the medium is the same.

For example, the setting unit may set a plurality of the first pixel lines positioned being separated by equal to or more than a predetermined number of lines to each other, and may set a plurality of the first common areas based on the plurality of first pixel lines.

According to this configuration, it is possible to determine whether the medium is the same based on the comparison result of a plurality of the first common areas. Accordingly, it is possible to improve accuracy in determining whether the medium is the same.

For example, the control unit may move the reading unit at a first speed until the reading unit reaches the first common area, and may move the reading unit at a second speed lower than the first speed after the reading unit reaching the first common area, during the third reading.

According to this configuration, it is possible to move the reading unit at a first speed until reaching the first common area, and move the reading unit at a second speed lower than the first speed after reaching the first common area. Accordingly, it is possible to move the reading unit at a high speed when the reading is not necessary so that it is possible to improve the processing speed in order to determine whether the medium is left behind.

For example, the control unit may move the reading unit to a standby position after it is determined that the medium is not present by the first determination unit.

According to this configuration, the reading unit is moved to a standby position when the medium is present, but the reading unit is moved to the standby position when the medium is not present. Accordingly, it is possible to prevent the movement of the reading unit in order to detect the medium being left behind so that it is possible to perform detection of the medium being left behind at a high speed.

Incidentally, the present invention may be realized not only as an image reading apparatus provided with components having such characteristics, but also as a notification method having steps of processes performed by the characteristic components. In addition, the present invention may be realized as a program for allowing a computer to function as the characteristic components included in the image reading apparatus, or a program allowing the computer to execute the characteristic steps included in the notification method. Needless to say, such a program may be distributed via a non-transitory computer-readable recording medium such as a CD-ROM (Compact Disc Read Only Memory) or via a communication network such as the Internet.

An image reading apparatus according to an aspect of the present invention is capable of preventing the increase of the number of components in order to detect a document being left behind on a document table.

### BRIEF DESCRIPTION OF DRAWINGS

FIG. 1 is a perspective view illustrating exterior of an image reading apparatus according to Embodiment 1.

FIG. 2 is a block diagram illustrating a functional configuration of the image reading apparatus according to Embodiment 1.

FIG. 3 is a flowchart illustrating processing operation of the image reading apparatus according to Embodiment 1.

FIG. 4 is a flowchart illustrating details of a setting process of a first partial area according to Embodiment 1.

FIGS. 5A and 5B are diagrams illustrating examples of the first partial area and a second partial area according to Embodiment 1.

FIG. 6 is a block diagram illustrating a functional configuration of an image reading apparatus according to Embodiment 2.

FIG. 7 is a flowchart illustrating processing operation of the image reading apparatus according to Embodiment 2.

FIG. 8 is a block diagram illustrating a functional configuration of an image reading apparatus according to Embodiment 3.

FIG. 9 is a flowchart illustrating processing operation of the image reading apparatus according to Embodiment 3.

FIG. 10 is a flowchart illustrating details of a setting process of a first partial area according to Embodiment 3.

FIGS. 11A and 11B are diagrams illustrating examples of a plurality of the first partial areas and a plurality of second partial areas according to Embodiment 3.

FIG. 12 is a block diagram illustrating a functional configuration of an image reading apparatus according to Embodiment 4.

FIG. 13 is a flowchart illustrating processing operation of the image reading apparatus according to Embodiment 4.

### DETAILED DESCRIPTION

Hereinafter, embodiments will be described in detail with reference to the drawings.

Incidentally, any embodiment to be described hereinafter illustrates a general or specific example. Numerical values, materials, constituent elements, layout and connection forms of the constituent elements, steps, the order of the steps, and the like in the embodiments are given merely as an example without limiting the scope of the claims. In addition, among the constituent elements in the embodiments hereinafter, constituent elements not recited in any one of the independent claims are described as optional constituent elements.

### Embodiment 1

### Hardware Configuration of Image Reading Apparatus

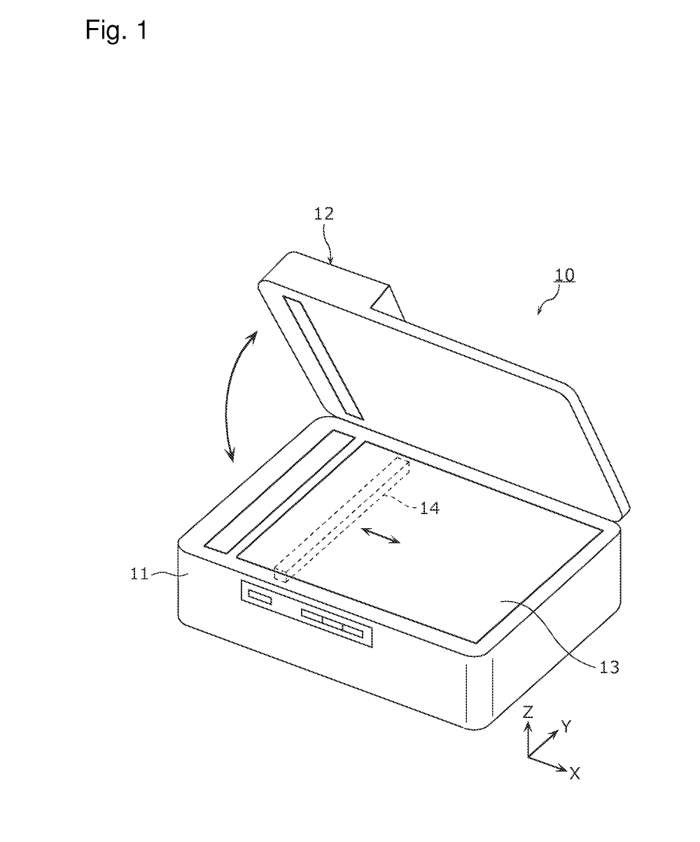

FIG. 1 is a perspective view illustrating exterior of an image reading apparatus according to Embodiment 1. An image reading apparatus 10 according to this embodiment is, for example, a flatbed-type image scanner. The image reading apparatus 10 is provided with a housing 11, a lid 12, a document table 13 and a scanning unit 14.

The housing 11 is configured to accommodate the scanning unit 14, a driving source (not illustrated) configured to drive the scanning unit 14 and the like. The housing 11 is made of, for example, resin.

The lid 12 is a member configured to block the document table 13 in an openable and closable manner. In a generally used situation, the lid 12 is opened when a document is placed on the document table 13, and the lid 12 is closed when the document is scanned.

The document is an object to be scanned. To be specific, examples of the document include an article, a photo, a book and the like. The document is also referred to as a medium.

The document table 13 is a transparent plate-like member which is provided on a top surface of the housing 11. To be specific, the document table 13 is, for example, a platen glass.

The scanning unit (reading unit) 14 is configured to scan the document placed on the document table 13 while moving in a predetermined direction (a scan direction and an X-axis direction). The scanning unit 14 includes, for example, a light source and a line image sensor. The line image sensor is provided with a plurality of imaging elements which is disposed side by side in a direction perpendicular to the predetermined direction (a line direction and a Y-axis direction). The line image sensor is, for example, a CIS (Contact Image Sensor) or a CCD (Charge Coupled Device) image sensor.

To be specific, the scanning unit 14 is driven by the driving source such as a motor, and moves in the scan direction. At the time, the light source irradiates the document placed on the document table with light. The line image sensor converts the light reflected from the document to an electrical signal.

### [Functional Configuration of Image Reading Apparatus]

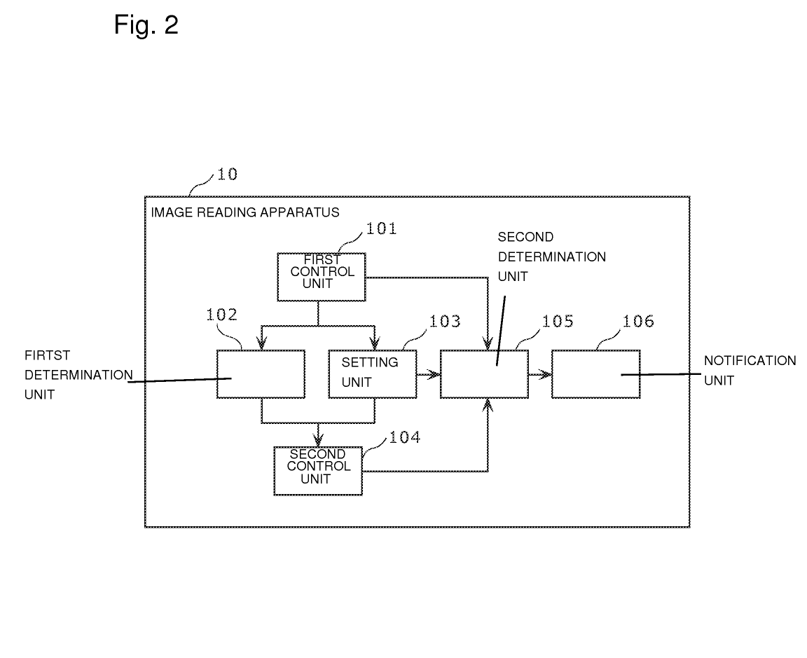

Next, a functional configuration of the image reading apparatus 10 according to this embodiment will be described. FIG. 2 is a block diagram illustrating the functional configuration of the image reading apparatus according to Embodiment 1. As illustrated in FIG. 2, the image reading apparatus 10 is provided with a first control unit 101, a first determination unit 102, a setting unit 103, a second control unit 104, a second determination unit 105 and a notification unit 106.

The first control unit 101 is configured to cause a first document placed on the document table 13 to be scanned by the scanning unit 14 thereby generating a first image. In other words, the first control unit 101 causes the scanning unit 14 to be moved in the scan direction so that the first document on the document table 13 is scanned.

Here, the first image is a digital image of the scanned first document. To be specific, examples of the first image include, a gray scale image, a color image and an image of a predetermined color (for example, red, green or blue).

The first determination unit 102 is configured to determine whether a second document is placed on the document table 13 by performing detection of an edge of the second document on the document table 13 after the first document is scanned. To be specific, the first determination unit 102 causes the scanning unit 14 to operate in, for example, the vicinity of a standby position of the scanning unit 14 on the document table 13 so as to detect difference in level between the lid 12 and the document caused by the thickness of the document.

The setting unit 103 is configured to set at least one first partial area in the first document based on an image characteristic of the first image. Here, a partial area of the document means a part of a surface (surface to be scanned) at the document table 13 side of the document placed on the document table 13.

To be specific, the setting unit 103 sets a first pixel line including the number of non-white pixels equal to or larger than a first threshold number among a plurality of pixel lines included in the first image, for example. The pixel line is a column of pixels arranged in the direction (the line direction and the Y-axis direction) perpendicular to the scan direction (the X-axis direction). Further, the setting unit 103 sets the first partial area based on the first pixel line.

Here, the non-white pixel is a pixel having a luminance value smaller than a predetermined luminance value. For example, in a case where the first image is a gray scale image, the non-white pixel is a pixel having a pixel value smaller than the predetermined luminance value. In addition, in a case where the first image is a color image represented according to an RGB color model, for example, the non-white pixel may be a pixel having an average value smaller than the predetermined luminance value, the average value of a pixel value of a red image, a pixel value of a green image and a pixel value of a blue image. In addition, in the case where the first image is the color image represented according to the RGB color model, for example, the non-white pixel may be a pixel having the pixel value of the red image (alternatively, the green image or the blue image) smaller than the predetermined luminance value.

Here, the predetermined luminance value is a luminance value for distinguishing whether or not a pixel is white. For example, the predetermined luminance value is a value smaller by a certain value than an upper limit of a luminance value which may be realized in the first image and the second image. The certain value may be set in advance based on experiments or experience, or may be zero. In addition, the predetermined luminance value may be, for example, a value depending on a luminance value of the first image. To be specific, the predetermined luminance value may be, for example, a value smaller by a certain value than a maximum luminance value of the first image.

In a case where it is determined that the second document is placed on the document table 13, the second control unit 104 causes the scanning unit 14 to scan at least one second partial area in the second document corresponding to at least one first partial area in the first document so as to generate at least one second image. To be specific, the second control unit 104 generates the second image of the second partial area positioned at the same position on the document table 13 as the first partial area, the second partial area having the same shape and size as the first partial area. The first partial area and the second partial area are collectively referred to also as a first common area.

Here, the second image is a digital image of the second partial area in the scanned second document. In addition, the second image is an image of the same type as the first image. In other words, in the case where the first image is the gray scale image, for example, the second image is also a gray scale image. In addition, in a case where the first image is the color image, for example, the second image is also a color image.

The second determination unit 105 is configured to determine whether the second document is the same as the first document by comparing an image of at least one first partial areas included in the first image with at least one second image (that is, an image of the second partial area). In other words, the second determination unit 105 determines that the second document is the same as the first document in a case where the image of the first partial area matches with an image of the second partial area. On the contrary, the second determination unit 105 determines that the second document is different from the first document in a case where the image of the first partial area does not match with the image of the second partial area.

The notification unit 106 is configured to notify determination information based on the determination result of the second determination unit 105. To be specific, the notification unit 106 notifies a user that the first document is left behind on the document table 13 in the case where it is determined that the second document is the same as the first document. For example, the notification unit 106 may notify the user of the first document being left behind by displaying a message or an image on a display unit (not illustrated). In addition, the notification unit 106 may notify the user of the first document being left behind by, for example, turning on or off a warning lamp (not illustrated). In addition, the notification unit 106 may notify the user of the first document being left behind by, for example, outputting warning sound. In addition, the notification unit 106 may notify the user of the first document being left behind by, for example, transmitting a message to another apparatus different from the image reading apparatus 10. In addition, the notification unit 106 may notify the user of the first document being left behind by arbitrarily combining the display of the message or the image on the display unit, turning on or off the warning lamp, and the output of the warning sound.

### [Operation of Image Reading Apparatus]

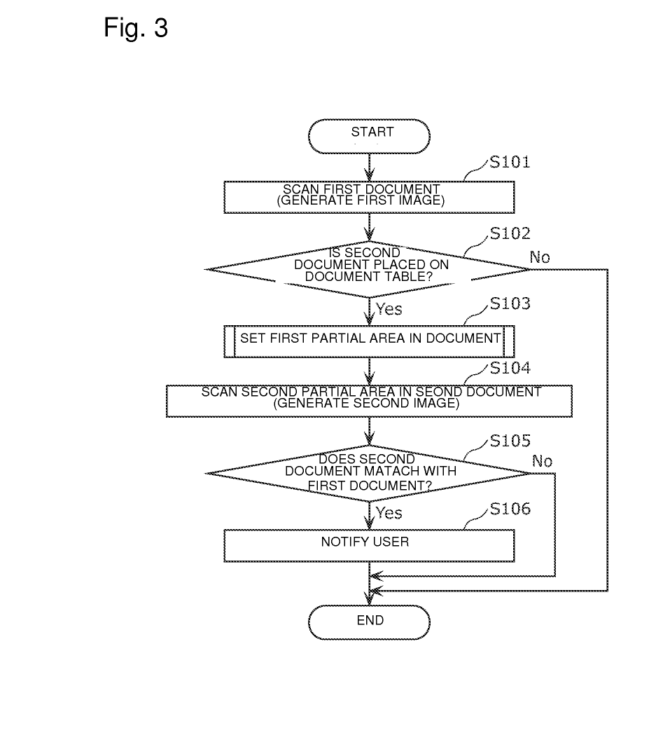

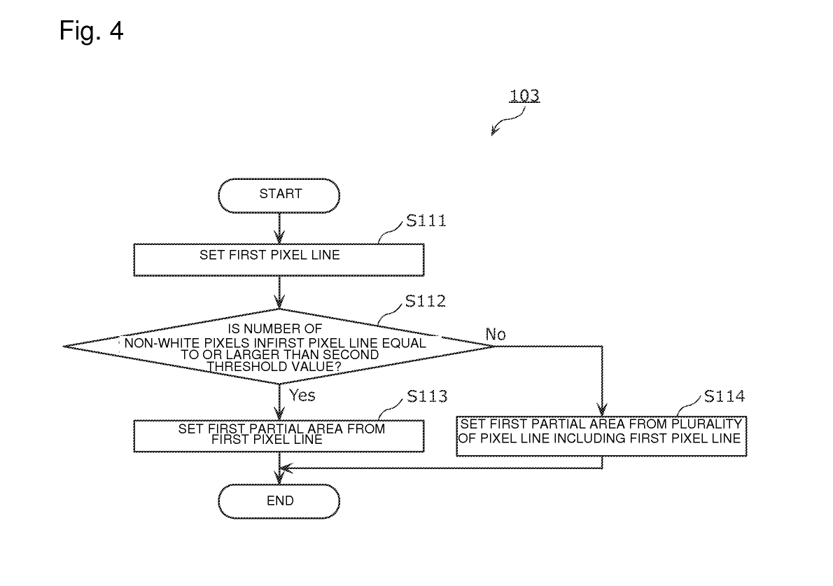

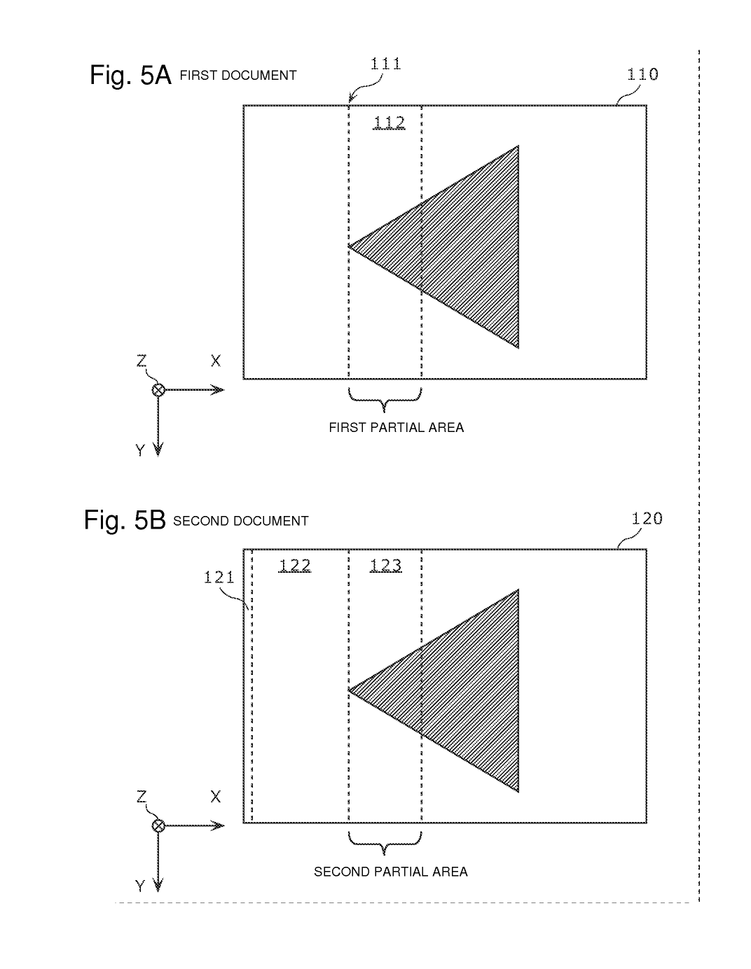

Next, a description will be made regarding operation of the image reading apparatus 10 having the configuration described above. FIG. 3 is a flowchart illustrating processing operation of the image reading apparatus according to Embodiment 1. FIG. 4 is a flowchart illustrating details of a setting process of the first partial area according to Embodiment 1. FIGS. 5A and 5B are diagrams illustrating examples of the first partial area and the second partial area according to Embodiment 1.

Incidentally, in FIGS. 5A and 5B, a first document 110 (FIG. 5A) and a second document 120 (FIG. 5B) are illustrated at the time of seen from the inside of the housing 11. In addition, the first document 110 and the second document 120 are scanned in a positive direction of an X axis (that is, in a direction from the left side to the right side in FIGS. 5A and 5B). In other words, in FIGS. 5A and 5B, the scan start position is a position at the right side of the first document 110 and the second document 120.

First, a description will be made regarding an entire flow of processes in the image reading apparatus 10 with reference to FIGS. 3, 5A and 5B.

The first control unit 101 generates the first image by causing the scanning unit 14 to scan the first document placed on the document table 13 (S101). For example, the scanning unit 14 scans the first document 110 illustrated in FIG. 5A from the left to the right along the X-axis direction. Further, the first control unit 101 stores the first image (data) in a memory.

the first determination unit 102 determines whether the second document is placed on the document table by performing detection of the edge of the second document on the document table 13 after the first document is scanned (S102). In the example of FIG. 5B, the first determination unit 102 performs the edge detection with respect to an image obtained by scanning an edge detection area 121, which is a topical area in the vicinity of the standby position of the scanning unit 14. Further, in a case where an edge (the edge of the document) of a predetermined direction is detected, the first determination unit 102 determines that the second document 120 is placed on the document table 13. On the contrary, in a case where the edge of the predetermined direction is not detected, the first determination unit 102 determines that the second document 120 is not placed on the document table 13.

The process of the first determination unit 102 in this Step S102 is performed, for example, when transmitting the first image to another device (for example, a server, a communication terminal or the like) is completed after the first document is scanned. In addition, the process of the first determination unit 102 may be performed, for example, when storing the first image in a recording medium (for example, a memory card, a USB (Universal Serial Bus) memory and the like) which may be attached to and detached from the image reading apparatus 10 is completed after the first document is scanned. In addition, the process of the first determination unit 102 may be performed, for example, when transmitting the first image is completed using a facsimile after the first document is scanned. In addition, the process of the first determination unit 102 may be performed, for example, when a predetermined time elapses after the scan of the first document is completed.

Here, in the case where it is determined that the second document is placed on the document table 13 (Yes in S102), the setting unit 103 sets the first partial area in the first document (S103). A detailed description will be made below regarding the setting process of the first partial area in this step S103 with reference to FIG. 4.

Subsequently, the second control unit 104 generates the second image by causing the scanning unit 14 to scan the second partial area in the second document corresponding to the first partial area in the first document (S104). In other words, the second control unit 104 generates the second image of the second partial area of which a shape, a size and a position on the document table 13 match with those of the first partial area.

In the example of FIG. 5B, the second control unit 104 moves the scanning unit 14 at a high speed (a first speed) in a non-scanning area 122. In addition, the second control unit 104 moves the scanning unit 14 at a low speed (a second speed) in a second partial area 123 (a scanning area). In other words, the second control unit 104 moves the scanning unit 14 at the first speed until the scanning unit 14 reaches the second partial area, and moves the scanning unit 14 at the second speed lower than the first speed after the scanning unit 14 reaches the second partial area. Incidentally, the second control unit 104 causes the scanning unit 14 to scan the second partial area 123 by moving the scanning unit 14 at the low speed in the second partial area 123, thereby generating the second image of the second partial area 123.

Next, the second determination unit 105 determines whether the second document is the same as the first document by comparing the image of the first partial area included in the first image with the second image (the image of the second partial area) (S105).

In the examples of FIGS. 5A and 5B, the second determination unit 105 determines whether the second document 120 is the same as the first document 110, for example, as follows. First, the second determination unit 105 reads out the image of a first partial area 112 in the first image from the memory. Further, the second determination unit 105 compares a value of a first pixel with a value of a second pixel corresponding to the first pixel, the second pixel included in the image (the second image) of the second partial area 123 for each of a plurality of the first pixels included in the first partial area 112. Here, in a case where all the values of the first pixels and the values of the second pixels match with one another in the image of the first partial area 112 and the image of the second partial area 123, the second determination unit 105 determines that the second document 120 is the same as the first document 110.

Here, in a case where it is determined that the second document is the same as the first document (Yes in S105), the notification unit 106 notifies the user that the second document (that is, the first document) is left behind on the document table 13 (S106), and ends the process.

On the contrary, in a case where it is determined that the second document is not placed on the document table 13 (No in S102), the process ends at the moment. In other words, in the case where it is determined that the second document is not placed on the document table 13, Steps S103 to S106 are not performed. In addition, also in a case where it is determined that the second document is not the same as the first document (No in S105), the process ends at the moment without performing Step S106.

Next, a detailed description will be made regarding the setting process of a first partial area in Step S103 of FIG. 3 with reference to FIGS. 4, 5A and 5B. Incidentally, hereinafter, the column of pixels arranged in the line direction (the Y-axis direction) in the first image will be referred to as a pixel line. In other words, the pixel line includes a plurality of pixels arranged in the direction perpendicular to the scan direction (the X-axis direction and the predetermined direction).

The setting unit 103 sets the first pixel line having the number of the non-white pixels equal to or larger than the first threshold number among the plurality of pixel lines included in the first image (S111). Here, in a case where two or more of the pixel lines each having the number of the non-white pixels equal to or larger than the first threshold number are included in the first image, the setting unit 103 sets a pixel line close to the scan start position as the first pixel line among the two or more of the pixel lines. In the example of FIG. 5A, a pixel line corresponding to an area on a dashed line 111 of the first document 110 is set as the first pixel line.

Here, the first threshold number is a lower limit value of the number of the non-white pixels for determining the pixel line in which the characteristic of the document is represented. In the example of FIG. 5A, “1” is used as the first threshold number.

Subsequently, the setting unit 103 determines whether the number of the non-white pixels included in the first pixel line is equal to or larger than a second threshold number which is larger than the first threshold number (S112). Here, the second threshold number is a lower limit value of the number of the non-white pixels required for distinguishing the first pixel line from a pixel line included in the image of another document. In the example of FIG. 5A, “10” is used as the second threshold number.

For example, in FIG. 5A, since only a vertex of a triangular object is present in the area on the dashed line 111, the number of the non-white pixels included in the first pixel line is “1”. Accordingly, the number “1” of the non-white pixels included in the first pixel line is determined to be below the second threshold number “10”.

Here, in a case where the number of the non-white pixels included in the first pixel line is equal to or larger than the second threshold number (Yes in S112), the setting unit 103 sets an area on the first document corresponding to the first pixel line as the first partial area (S113). For example, if the first pixel line includes the non-white pixel equal to or larger than the second threshold number “10”, the area on the dashed line 111 is set as the first partial area.

Meanwhile, in a case where the number of the non-white pixels included in the first pixel line is below second threshold number (No in S112), the setting unit 103 sets an area on the first document 110 corresponding to the plurality of pixel lines including the first pixel line as the first partial area (S114). For example, the setting unit 103 sets an area between the first pixel line and a pixel line moved from the first pixel line by the predetermined number of lines in the X-axis direction as the first partial area. In the example of FIG. 5A, the first partial area 112 including the area on the dashed line 111 corresponding to the first pixel line is set.

### [Effect]

As described above, according to the image reading apparatus 10 according to this embodiment, it is determined whether the second document is the same as the first document by comparing the first image and the second image which are generated, respectively, by scanning the first document and the second document using the scanning unit 14. Accordingly, it is possible to determine whether the first document is left behind using the scanning unit 14 so that a dedicated sensor for detecting the document being left behind on the document table is not necessary. In other words, it is possible to prevent the increase of the number of components in order to detect the document being left behind on the document table.

Further, according to the image reading apparatus 10 according to this embodiment, it is determined that the second document is the same as the first document by comparing the image (a part of the first image) of the first partial area in the first document and the image (the second image) of the second partial area in the second document. Accordingly, it is not necessary to scan the entire area of the second document in order to determine whether the first document is left behind. In other words, it is possible to realize reduction of processing loads and improvement of processing speed in order to determine whether the first document is left behind.

In addition, according to the image reading apparatus 10 according to this embodiment, in the case where it is determined that the second document is placed on the document table based on the detection result of the edge of the second document, the scan of the second partial area in the second document and the comparison between the part of the first image and the second image are performed. In other words, it is possible to determine whether the first document is left behind on the document table based on the stepwise determination result according to the first determination unit 102 and the second determination unit 105. The detection of the edge of the second document according to the first determination unit 102 may be performed based on the scanning result of the topical area in the vicinity of the standby position of the scanning unit 14. Accordingly, in a situation where the second document is not placed on the document table, it is possible to prevent the scanning unit 14 from moving unnecessarily so that it is possible to realize reduction of processing loads and improvement of processing speed in order to determine whether the first document is left behind.

In addition, according to the image reading apparatus 10 according to this embodiment, it is possible to set the first partial area based on the image characteristic of the first image. In other words, a partial area for comparing the first document and the second document may be set adaptively according to the image characteristic. Accordingly, it is possible to prevent setting an area including a lot of white pixels (that is, an area having few image characteristics) as the first partial area as compared to a case where a fixed area (for example, a central area) in the first document is set as the first partial area. As a result, it is possible to improve accuracy in determining whether the second document is the same as the first document.

In addition, according to the image reading apparatus 10 according to this embodiment, it is possible to set the first partial area based on the first pixel line having the number of non-white pixels equal to or larger than the first threshold number. Accordingly, it is possible to prevent setting the area including a lot of the white pixels (that is, the area having few image characteristics) as the first partial area so that it is possible to improve accuracy in determining whether the second document is the same as the first document.

In addition, according to the image reading apparatus 10 according to this embodiment, it is possible to set the pixel line closest to the scan start position as the first pixel line among the two or more of the pixel lines. Accordingly, it is possible to prevent the scanning unit from moving in order to scan the second partial area. As a result, it is possible to realize reduction of processing loads and improvement of processing speed in order to determine whether the first document is left behind.

In addition, according to the image reading apparatus 10 according to this embodiment, it is possible to change a size of the first partial area according to the number of the non-white pixels included in the first pixel line. Accordingly, it is possible to prevent setting the area including a lot of the white pixels (that is, the area having few image characteristics) as the first partial area. As a result, it is possible to improve accuracy in determining whether the second document is the same as the first document.

In addition, according to the image reading apparatus 10 according to this embodiment, it is possible to move the scanning unit at the first speed until reaching the second partial area, and move the scanning unit at the second speed lower than the first speed after reaching the second partial area. Accordingly, it is possible to move the reading unit at a high speed when the scanning unit is not necessary so that it is possible to improve the processing speed in order to determine whether the first document is left behind.

### Embodiment 2

Next, Embodiment 2 will be described.

An image reading apparatus according to this embodiment further determines whether a position of the edge of the first document matches with a position of the edge of the second document in a case where it is determined that the second document is placed on the document table. Further, the image reading apparatus according to this embodiment scans the second partial area in the second document in a case where the position of the edge of the first document matches with the position of the edge of the second document.

Hereinafter, the image reading apparatus according to this embodiment will be described focusing on a fact different from Embodiment 1.

### [Functional Configuration of Image Reading Apparatus]

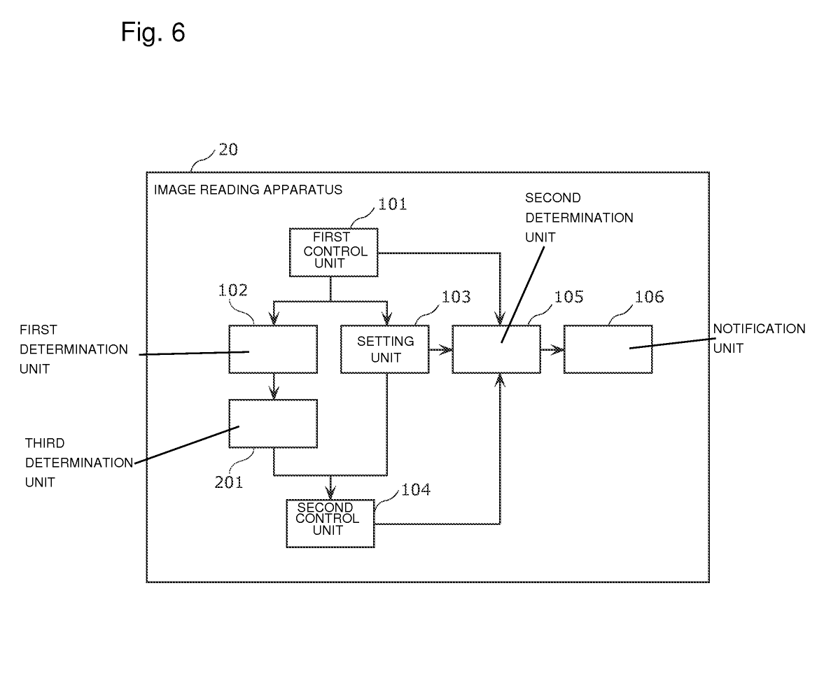

FIG. 6 is a block diagram illustrating a functional configuration of the image reading apparatus according to Embodiment 2. Incidentally, in FIG. 6, a component having the same or similar function as in FIG. 2 will be attached with the same reference numeral, and the description thereof will be appropriately omitted.

As illustrated in FIG. 6, an image reading apparatus 20 is provided with the first control unit 101, the first determination unit 102, the setting unit 103, the second control unit 104, the second determination unit 105, the notification unit 106 and a third determination unit 201.

The third determination unit 201 is configured to determine whether the position of the edge of the first document matches with the position of the edge of the second document in the case where it is determined that the second document is placed on the document table 13. To be specific, the third determination unit 201 determined whether, for example, the position of the edge of a predetermined direction, which has been detected in the image obtained by scanning the second document matches the position of the edge of the predetermined direction that has been detected in the first image.

### [Operation of Image Reading Apparatus]

Next, a description will be made regarding operation of the image reading apparatus 20 having the configuration described above.

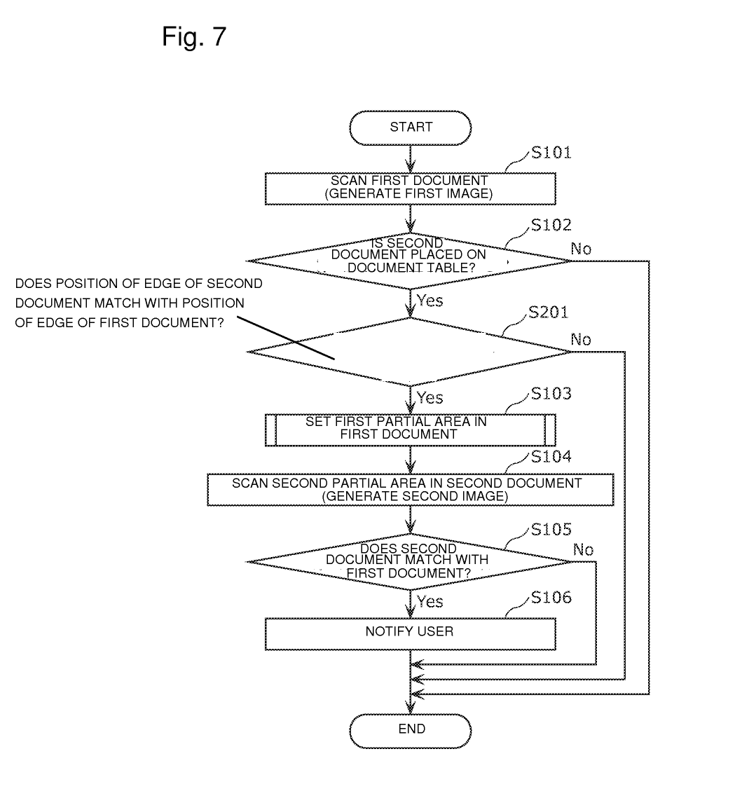

FIG. 7 is a flowchart illustrating processing operation of the image reading apparatus according to Embodiment 2. Incidentally, in FIG. 7, a step in which the same or similar process as in FIG. 3 is performed will be attached with the same reference numeral, and the description thereof will be appropriately omitted.

In the case where it is determined that the second document is placed on the document table 13 (Yes in S102), the third determination unit 201 determines whether the position of the edge of the first document matches with the position of the edge of the second document (S201).

Here, in a case where the position of the edge of the first document matches with the position of the edge of the second document (Yes in S201), the setting unit 103 sets the first partial area in the first document (S103). On the contrary, in a case where it is determined that the position of the edge of the first document does not match with the position of the edge of the second document (No in S201), the process ends without performing Steps S103 to S106.

### [Effect]

As described above, according to the image reading apparatus 20 according to this embodiment, in the case where it is determined that the position of the edge of the first document matches with the position of the edge of the second document, it is possible to cause the scanning unit to scan at least one second partial area in the second document. Accordingly, it is possible to cancel the scanning of the second partial area in the second document in a case where a size of the first document is different from a size of the second document, or the like. In other words, it is possible to realize reduction of processing loads and improvement of processing speed in order to determine whether the first document is left behind.

### Embodiment 3

Next, Embodiment 3 will be described.

An image reading apparatus according to this embodiment determines whether the second document is the same as the first document by comparing images of a plurality of the first partial areas with images of a plurality of the second partial areas.

Hereinafter, the image reading apparatus according to this embodiment will be described focusing on a fact different from Embodiment 1.

### [Functional Configuration of Image Reading Apparatus]

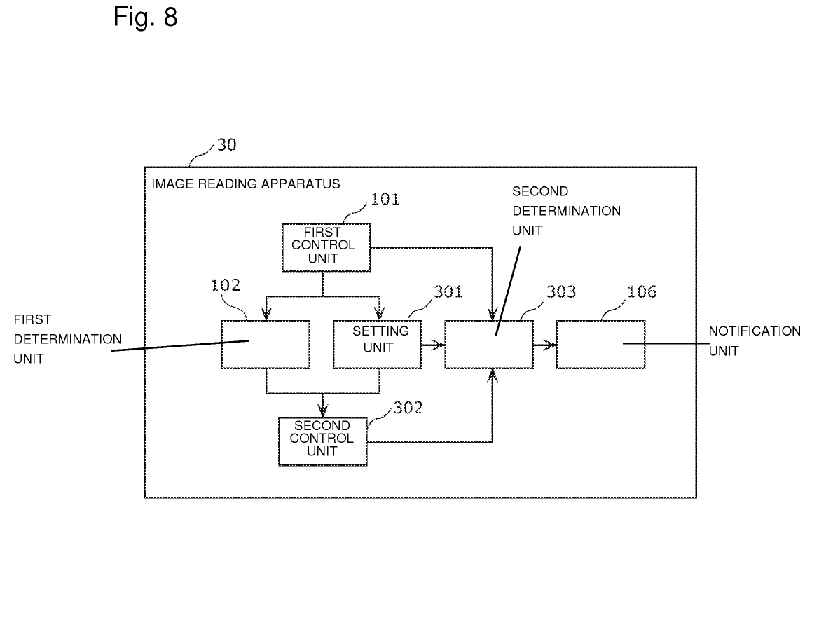

FIG. 8 is a block diagram illustrating a functional configuration of the image reading apparatus according to Embodiment 3. Incidentally, in FIG. 8, a component having the same or similar function as in FIG. 2 will be attached with the same reference numeral, and the description thereof will be appropriately omitted.

As illustrated in FIG. 8, an image reading apparatus 30 is provided with the first control unit 101, the first determination unit 102, a setting unit 301, a second control unit 302, a second determination unit 303 and the notification unit 106.

The setting unit 301 is configured to set a plurality of the first pixel lines positioned being separated by equal to or more than the predetermined number of lines from each other. Further, the setting unit 301 sets a plurality of the first partial areas based on the plurality of first pixel lines.

The second control unit 302 is configured to generate a plurality of second images by causing the scanning unit 14 to scan a plurality of the second partial areas.

The second determination unit 303 is configured to determine whether the second document is the same as the first document by comparing the images of the plurality of first partial areas with the plurality of second images (the images of the plurality second partial areas).

### [Operation of Image Reading Apparatus]

Next, a description will be made regarding operation of the image reading apparatus 30 having the configuration described above.

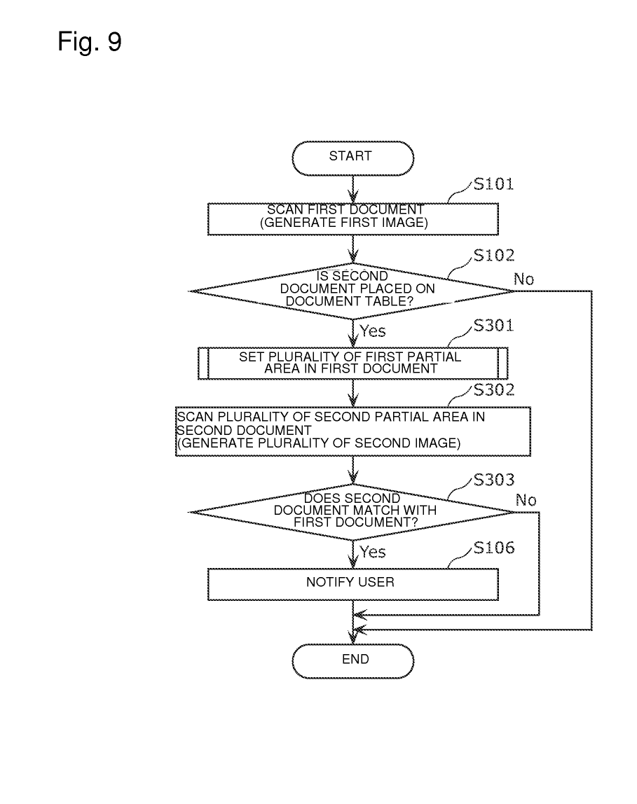

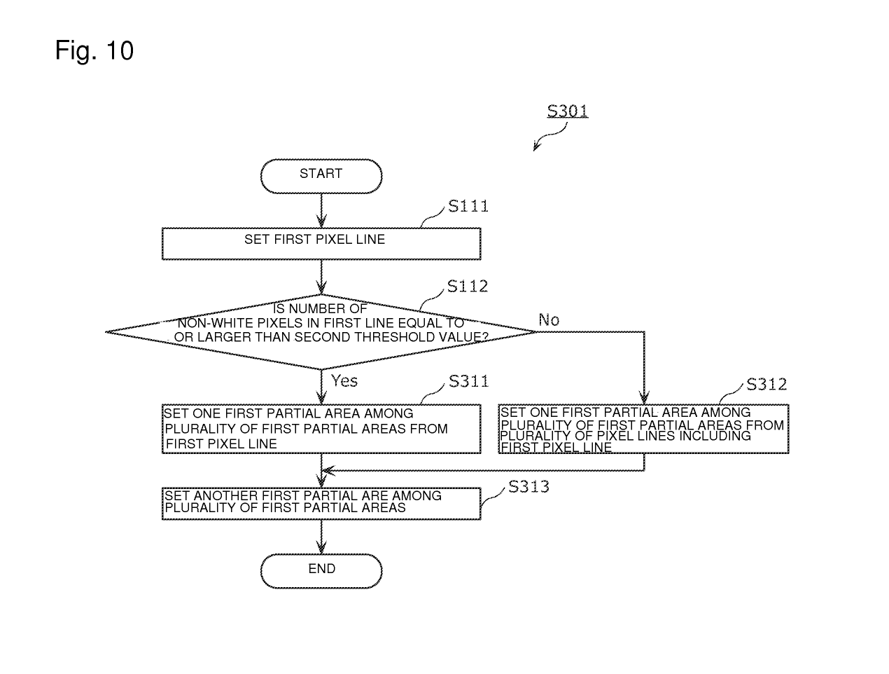

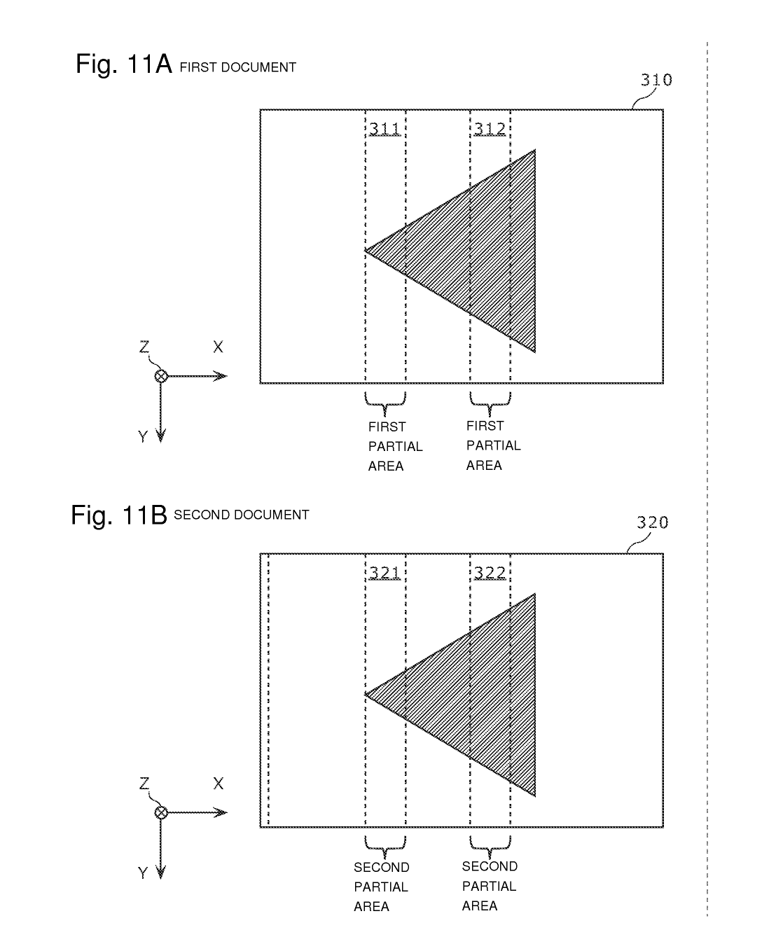

FIG. 9 is a flowchart illustrating processing operation of the image reading apparatus according to Embodiment 3. FIG. 10 is a flowchart illustrating details of a setting process of a first partial area according to Embodiment 3. FIGS. 11A and 11B are diagrams illustrating examples of a plurality of the first partial areas and a plurality of second partial areas according to Embodiment 3. Incidentally, in FIGS. 9 and 10, a step in which the same or similar process as in FIGS. 3 and 4 is performed will be attached with the same reference numeral, and the description thereof will be appropriately omitted.

First, a description will be made regarding an entire flow of the process in the image reading apparatus 30 with reference to FIGS. 9, 11A and 11B.

In the case where it is determined that the second document is placed on the document table 13 (Yes in S102), the setting unit 301 sets the plurality of first pixel lines positioned being separated by equal to or more than the predetermined number of lines from each other (S301). A detailed description will be made below regarding the setting process of the plurality of first partial areas in this Step S301 with reference to FIG. 10.

Subsequently, the second control unit 302 generates the plurality of second images by causing the scanning unit 14 to scan the plurality of second partial areas in the second document (S302). In other words, the second control unit 302 generates the plurality of second images of the plurality of second partial areas, of which shapes, sizes and positions on the document table 13 respectively match with those of the plurality of first partial areas.

In an example of FIG. 11B, the second control unit 302 generates the second image of a second partial area 321 and the second image of a second partial area 322 by causing the scanning unit 14 to scan the second partial areas 321 and 322, respectively.

Next, the second determination unit 303 determines whether the second document is the same as the first document by comparing the images of the plurality of first partial areas included in the first image with the plurality of second images (the images of the plurality of second partial areas) (S303).

In examples of FIGS. 11A and 11B, the second determination unit 303 determines whether a second document 320 is the same as a first document 310, for example, as follows. First, the second determination unit 303 reads out the image of the first partial area 112 in the first image from the memory. Further, the second determination unit 303 compares a first luminance value of a first pixel and a second luminance value of a second pixel corresponding to the first pixel, the second pixel included in the images (the second images) of the second partial areas 321 and 322 for each of a plurality of the first pixels included in the images of first partial areas 311 and 312. Here, the second determination unit 303 determines that the second document 320 is the same as the first document 310 in a case where all the first luminance values match with the second luminance values between the image of the first partial area 311 and the image of the second partial area 321, and between the image of the first partial area 312 and the image of the second partial area 322.

Next, a detailed description will be made regarding the setting process of the plurality of first partial areas in Step S301 in FIG. 9 with reference to FIGS. 10, 11A and 11B.

Here, in a case where the number of the non-white pixels included in the first pixel line is equal to or larger than the second threshold number (Yes in S112), the setting unit 301 sets an area on the first document corresponding to the first pixel line as one first partial area among the plurality of first partial areas (S311).

On the contrary, in a case where the number of the non-white pixels included in the first pixel line is below the second threshold number (No in S112), the setting unit 301 sets an area on the first document 110 corresponding to the plurality of pixel lines including the first pixel line as one first partial area among the plurality of first partial areas (S312). For example, the setting unit 301 sets an area between the first pixel line and the pixel line moved from the first pixel line by a predetermined line number in the X-axis direction as the first partial area. In the example of FIG. 11A, the first partial area 311 is set as one first partial area among the plurality of first partial areas.

Next, the setting unit 301 sets another first partial area among the plurality of first partial areas (S313). For example, the setting unit 301 sets an area separated by a predetermined line number from the first partial area set in Step S312 as another first partial area among the plurality of first partial areas. In the example of FIG. 11A, the first partial area 312 is set as another first partial area among the plurality of first partial areas.

### [Effect]

As described above, according to the image reading apparatus 30 according to this embodiment, it is possible to determine whether the second document is the same as the first document based on the comparison result of the plurality of partial areas. Accordingly, it is possible to improve accuracy in determining whether the second document is the same as the first document.

### Embodiment 4

Next, Embodiment 4 will be described.

An image reading apparatus according to this embodiment moves the scanning unit to the standby position after it is determined that the document is not placed on the document table without moving the scanning unit to the standby position immediately after scanning the document.

Hereinafter, the image reading apparatus according to this embodiment will be described with reference to the drawings. Incidentally, there may be a case where illustration or a description is omitted regarding the same or similar configuration as in the image reading apparatus according to Embodiment 1.

### [Functional Configuration of Image Reading Apparatus]

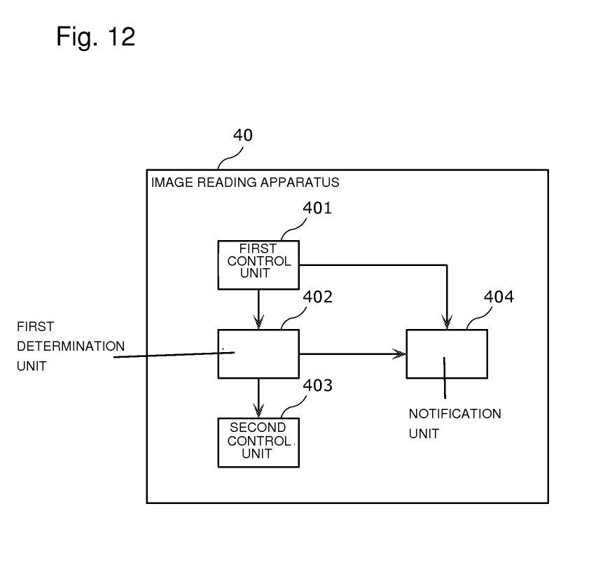

A description will be made regarding a functional configuration of an image reading apparatus 40 according to this embodiment. FIG. 12 is a block diagram illustrating a functional configuration of an image reading apparatus according to Embodiment 4. As illustrated in FIG. 12, the image reading apparatus 40 is provided with a first control unit 401, a first determination unit 402, a second control unit 403 and a notification unit 404.

The first control unit 401 is configured to generate an image by causing the scanning unit 14 to scan the document placed on the document table 13. In other words, the first control unit 401 moves the scanning unit in the scan direction to scan the document on the document table 13.

Further, the first control unit 401 causes the scanning unit 14 to stop at a document position after scanning the document. The document position is a position at which the document is readable. For example, the document position is set based on the generate image. To be specific, the document position is set based on, for example, an edge included in the generated image.

The first determination unit 402 determines whether the document is placed on the document table 13 by performing detection of the document on the document table after the document is scanned. To be specific, the first determination unit 402 detects deference in levels between the lid 12 and the document caused by the thickness of the document by operation the scanning unit 14 in the vicinity of the standby position of the scanning unit 14 on the document table 13, for example.

The second control unit 403 moves the scanning unit 14 to the standby position after it is determined that the document is not placed on the document table 13. In addition, the second control unit 403 outputs the image generated by the first control unit 401 after it is determined that the document is not placed on the document table 13. To be specific, the second control unit 403 outputs the image to, for example, a printing unit (not illustrated), the display unit (not illustrated) or a communication unit (not illustrated).

The notification unit 404 is configured to perform notification to a user so that the document is removed from the document table 13. The notification to the user may be performed using, for example, a display, a warning lamp, a speaker and the like.

### [Operation of Image Reading Apparatus]

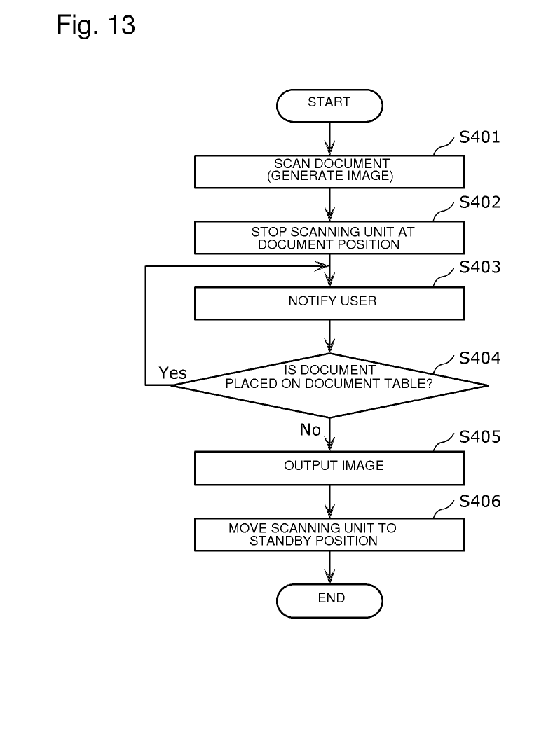

Next, a description will be made regarding operation of the image reading apparatus 40 having the configuration described above. FIG. 13 is a flowchart illustrating processing operation of the image reading apparatus according to Embodiment 4.

First, the first control unit 401 generates the image by causing the scanning unit 14 to scan the document placed on the document table 13 (S401). The first control unit 401 causes the scanning unit 14 to stop at the document position (S402). In other words, the first control unit 401 causes the scanning unit 14 to standby at the position at which the document is readable without causing the scanning unit 14 to return to the standby position. The notification unit 404 performs the notification for removal of the document (S403).

Next, the first determination unit 402 determines whether the document is placed on the document table 13 by performing detection of the document on the document table 13 after the document is scanned (S404). For example, the first determination unit 402 determines whether the document is placed when opening or closing of the lid 12 is detected. The detection of opening and closing of the lid 12 may be performed by an opening and closing sensor, or may be performed by the scanning unit 14. In addition, the first determination unit 402 may determine whether the document is placed when a push button for indicating that the document has already been removed is pressed by the user, for example.

Here, in a case where it is determined that the document is not placed on the document table 13 (No in S404), the second control unit 403 outputs the image generated by the first control unit 401 (S405). For example, the second control unit 403 transmits the image to a transmission unit (not illustrated). Further, the second control unit 403 moves the scanning unit 14 to the standby position (S406), and the process of the image reading apparatus 40 ends.

On the contrary, in a case where it is determined that the document is placed on the document table 13 (Yes in S404), the process returns to Step S403. In other words, in the case where it is determined that the document is placed on the document table 13, the second control unit 403 does not output the image and does not move the scanning unit 14 to the standby position.

### [Effect]

As described above, according to the image reading apparatus 40 according to this embodiment, the scanning unit does not move to the standby position when the document is placed on the document table, but the scanning unit moves to the standby position when the document is not placed on the document table. Accordingly, it is possible to prevent the movement of the scanning unit in order to detect whether the document is left behind, so that it is possible to detect whether the document is left behind at a high speed.

In addition, according to the image reading apparatus 40 according to this embodiment, the image is not output in the case where the document is placed on the document table. In other words, if the document on the document table is not removed, a predetermined process (for example, printing, display, transmission and the like of the scanned result (image)) of a user does not end, and thus, it is possible to prevent the document from being left behind.

### Other Embodiment

Hereinbefore, the image reading apparatus according to the embodiments of the present invention has been described, but the present invention is not limited to the embodiments. The scope of the present invention includes any modification of the embodiments that may be assumed by a person skilled in the art and an embodiment made by combining the components of different embodiments.

For example, any one of the above-described Embodiments 1 to 3 and the above-described Embodiment 4 may be combined. In other words, in any one of Embodiments 1 to 3, the second control unit may move the scanning unit to the standby position after it is determined that the second document is not placed on the document table. In other words, the second control unit may control the output of the image based on the determination result of the second determination unit. For example, the second control unit may transmit the image to the transmission unit based on the determination result of the second determination unit.

Incidentally, in the above-described Embodiments 1 to 3, the setting of the first partial area in the first document is performed after determining whether the second document is placed on the document table, but the present invention may not be limited thereto. In other words, the setting of the first partial area in the first document may be performed before determining whether the second document is placed on the document table. In this case, only an image of the first partial area of the first image may be stored in the memory. Accordingly, it is possible to reduce a memory area to store the first image.

Incidentally, in the above-described Embodiments 1 to 3, the size of the first partial area is changed according to the number of the non-white pixels in the first pixel line, but the first partial area is not necessarily set in such a manner. For example, an area in the first document corresponding to the first pixel line is constantly set as the first partial area using a relatively large value as the first threshold number.

Incidentally, in the above-described Embodiments 1 to 3, the image reading apparatus is provided with the setting unit, but the setting unit may not be provided. In other words, the image reading apparatus may determine whether the first document is left behind using the first partial area at a predetermined position having a predetermined shape and size.

Incidentally, in the above-described Embodiments 1 to 3, the description has been made regarding the case where it is determined that the second document is the same as the first document when the image of the first partial area completely matches with the image of the second partial area, but the present invention is not limited thereto. For example, it may be determined that the second document is the same as the first document in a case where a value (for example, SAD (Sum of Absolute Differences)) indicating difference between the image of the first partial area and the image of the second partial area is below a threshold.

Incidentally, in each of the embodiments described above, the standby position (the scan start position) of the scanning unit is the left side of the image reading apparatus, but the present invention may not be limited thereto. For example, the standby position of the scanning unit may be the left side of the image reading apparatus.

Incidentally, the image reading apparatus may be provided with the printing unit (for example, an inkjet printer or a laser printer). In addition, the image reading apparatus may be provided with a facsimile communication unit. In other words, the image reading apparatus may be a so-called MFP (Multifunction Printer/Peripheral/Product).

An image reading apparatus according to an aspect of the present invention may be employed as, for example, an image scanner, a copier and the like.
10, 20, 30, 40 image reading apparatus
11 housing
12 lid
13 document table
14 scanning unit
101, 401 first control unit
102, 402 first determination unit
103, 301 setting unit
104, 302, 403 second control unit
105, 303 second determination unit
106, 404 notification unit
201 third determination unit

What is claimed is:

1. An image reading apparatus comprising:
a reading unit that reads a medium;
a control unit that generates a first image based on a result of a first reading which reads the medium and generate a second image based on a result of a second reading which is performed at a different timing from the first reading; and
a first determination unit that determines presence or absence of the medium based on a comparison result of a common area between the first image and the second image.

2. The image reading apparatus according to claim 1, wherein
the reading unit performs a third reading based on a determination result of the first determination unit,
the control unit generates a third image based on the third reading, and
the determination unit includes a second determination unit that determines that the medium is the same based on a comparison result of a first common area between the first image and the third image.

3. The image reading apparatus according to claim 2, further comprising:
a notification unit that notifies determination information based on a determination result of the second determination unit.

4. The image reading apparatus according to claim 3, wherein the control unit further includes a transmission unit that transmits the first image based on a determination result of the second determination unit.

5. The image reading apparatus according to claim 1, wherein the common area is an edge portion of the medium.

6. The image reading apparatus according to claim 2, wherein
the reading unit performs the third reading in a case where positions of edge portions of the medium match with one another in the first determination unit.

7. The image reading apparatus according to claim 2, further comprising:
a setting unit that sets the first common area based on an image characteristic of the first image.

8. The image reading apparatus according to claim 7, wherein
the first image includes a plurality of pixel lines including a plurality of pixels arranged in a direction perpendicular to the predetermined direction, and
the setting unit sets at least one first pixel line having the number of non-white pixels equal to or larger than a first threshold number, the non-white pixel having a luminance value smaller than a predetermined luminance value, among the plurality of pixel lines included in the first image, and sets the first common area based on the at least one first pixel line.

9. The image reading apparatus according to claim 8, wherein the setting unit sets a pixel line closest to a start position of reading as the first pixel line among two or more of the pixel lines in a case where the two or more of the pixel lines each including the number of non-white pixels equal to or larger than the first threshold number are included in the first image.

10. The image reading apparatus according to claim 9, wherein the setting unit sets an area on the medium corresponding to the first pixel line as the first common area in a case where the number of non-white pixels included in the first pixel line is equal to or larger than a second threshold number which is larger than the first threshold number, and sets an area on the medium corresponding to the plurality of pixel lines including the first pixel line as the first common area in a case where the number of non-white pixels included in the first pixel line is below the second threshold number.

11. The image reading apparatus according to claim 8, wherein the setting unit sets a plurality of the first pixel lines positioned being separated by equal to or more than a predetermined number of lines to each other, and sets a plurality of the first common areas based on the plurality of first pixel lines.

12. The image reading apparatus according to claim 2, wherein the control unit moves the reading unit at a first speed until the reading unit reaches the first common area, and moves the reading unit at a second speed lower than the first speed after the reading unit reaching the first common area, during the third reading.

13. The image reading apparatus according to claim 2, wherein the control unit moves the reading unit to a standby position after it is determined that the medium is not present by the first determination unit.
